(19) United States
(12) Patent Application Publication
(10) Pub. No.: US 2003/0015810 A1
(43) Pub. Date: Jan. 23, 2003

(54) Method of producing optical storage media and resulting products

(75) Inventor: Ralf Rosowski, Bielefeld (DE)

Correspondence Address: Robert E. Muir, Esq., Husch & Eppenberger, LLC, Suite 1400, 401 Main Street, Peoria, IL, 61602-1241, US

(73) Assignee: MultimediaPrint GmbH

(21) Appl. No.: 10/194,884

(22) Filed: Jul. 12, 2002

Related U.S. Application Data
(63) Continuation of application No. PCT/EP00/12358, filed on Jul. 19, 2001.

(51) Int. Cl. B29D 11/00

(52) U.S. Cl. 264/1.33; 264/1.38; 264/284; 264/1.6; 264/1.7; 264/40.1

(57) ABSTRACT

A method of producing optical storage media includes the steps of providing a supply of thixotropic material in liquid form; coating a sheet of plastic film with the thixotropic material in a layer of predetermined thickness; applying heat to the coating of thixotropic material and drying the same to a semi-solid state; providing an embossing face which contains a negative of a storage medium of information to be transferred; embossing the dried semi-solid coating of thixotropic material with the embossing face and thereby transferring the information to the semi-solid coating; and applying ultra violet energy to the embossed face of the semi-solid coating to cure the coating to a solid state. An optical storage medium produced by the above method includes a sheet of flexible plastic material; a layer of ultra violet cured thixotropic material on the sheet of flexible plastic material, the thixotropic material having information embossed into a surface thereof opposite the flexible plastic material while the thixotropic material is in a semi-solid state and before curing; and a protective coating extending over the embossed surface.

### CROSS REFERENCE TO RELATED APPLICATIONS

This application is a continuation of PCT Application No. PCT/EP00/12358 filed Dec. 7, 2000 and which named the United States as a designated country. PCT Application PCT/EP00/12358 was published on Jul. 19, 2001 as Publication No. WO 01/52252 and claims priority of German Application 100 01 160.8 filed on Jan. 13, 2000.

### FIELD OF THE INVENTION

This invention relates generally to information storage devices and, more particularly, to a method of producing a substrate for fabricating optical storage media and of fabricating such optical storage media, and to a resulting optical storage media product.

### BACKGROUND OF THE INVENTION

The best known optical storage media of the type involved here include the CD-Audio and the CD-ROM, whose mechanical and electrical parameters are largely standardized and put down in DIN EN 60908 as well as IEC 908+A1 and in the Yellow Book. In an injection molding process, the storage media are molded out of polycarbonate from an embossing die, on which the molded surface structure in the form of the side bearing pits and lands is metallized, is provided with a protective lacquer and mostly printed with an indication of the contents etc. on the same side. The information is read out from the opposite, transparent side, i.e., through the polycarbonate.

Attempts have already been made at replacing the discontinuous manufacturing or replication process briefly outlined above by a continuous process, e.g. WO 97/12279. The basic idea is to clamp the die bearing the negative of the surface structure to be generated onto the periphery of a roller, and to pass a plastic film tape drawn off from a roller between this roller and a counter-roller, so as to transfer the surface structure by embossing. However, this method has not been developed enough that it is ready to go into production.

For producing certain microoptical surface structures, in particular for producing embossed holograms, continuous methods are known, but so far no attempts have been made at transferring such methods to the production of optical storage media of the type mentioned above.

From German Patent No. 41 32 476 A1, for instance, there is known a method for the simultaneous replication and direct application of holograms and other diffraction gratings to a printing material, wherein at least one radiation-curable lacquer coating is applied to the latter, and by means of such lacquer coating the surface structure is molded from a die clamped onto a hollow roller. Along with the molding process, the lacquer coating should then be cured by means of ultraviolet light through the UV-transparent hollow roller and the likewise UV-transparent die. The practical realization of this method fails, however, because of the high costs of an UV-transparent hollow roller and an UV-transparent die.

Another method of producing microoptical surface structures, e.g., holograms, is known from German Patent No. 197 46 268 A1. As in the above-mentioned method, a radiation-curable lacquer coating is applied to a plastic film. During the application and subsequent molding, the viscosity of this lacquer coating is adjusted to a predetermined value by a controlled supply of heat and is kept constant. During molding, the lacquer coating is already cured by irradiation with ultraviolet light. Thus, the method can only be performed with special lacquers. Furthermore, adjusting and keeping constant a certain viscosity of the lacquer requires a very efficient and fast control.

U.S. Pat. Nos. 4,758,296 and 4,906,315 disclose further methods for the continuous production of surface relief holograms, which methods are based on molding a hologram master in the form of an endless loop by applying a radiation-curable synthetic resin layer, curing the synthetic resin layer still in contact with the hologram master, and subsequently removing the same by means of a supplied transfer tape made of polyester.

These known methods are too expensive and/or too inaccurate for the production of optical storage media, because their pits, to be more precise the pit/land transitions, must be replicated very accurately because every single pit/land transition embodies a binary information element. In contrast, in a hologram an inaccurate replication is known to lead not to a loss of information, but only to a loss of contrast.

The present invention is directed overcoming one or more the problems set forth above.

### SUMMARY OF THE INVENTION

An aspect of the present invention is to provide a method for at least semi-continuous production of optical storage media.

In accordance with the above aspect of the invention, there is provided a method that includes, in various combinations, the steps of providing a supply of thixotropic material in liquid form; coating a sheet of plastic film with the thixotropic material in a layer of predetermined thickness; applying heat to the coating of thixotropic material and drying the same to a semi-solid state; providing an embossing face which contains a negative of a storage medium of information to be transferred; embossing the dried semi-solid coating of thixotropic material with the embossing face and thereby transferring the information to the semi-solid coating; and applying ultra violet energy to the embossed face of the semi-solid coating to cure the coating to a solid state.

There is also provided an optical storage medium produced by the disclosed method that includes a sheet of flexible plastic material; a layer of ultra violet cured thixotropic material on the sheet of flexible plastic material, the thixotropic material having information embossed into a surface thereof opposite the flexible plastic material while the thixotropic material is in a semi-solid state and before curing; and a protective coating extending over the embossed surface.

These aspects are merely illustrative aspects of innumerable aspects associated with present invention and should not be deemed as limiting in any manner. These and other aspects, features and advantages of the present invention will become apparent form the following detailed description when taken in conjunction with referenced drawings.

### BRIEF DESCRIPTION OF THE DRAWINGS

Reference is now made to the drawings, which illustrate the best known mode of carrying out the invention and wherein the same reference characters indicate the same or similar parts throughout the views.

FIG. 1 is a schematic diagram of an apparatus for the continuous production of optical storage media according to one embodiment of the present invention.

FIG. 2 is a schematic cross section of a first embodiment of an optical storage medium produced thereby.

FIG. 2a is detailed view of that portion of FIG. 2 contained within circle “X.”

FIG. 3 is a schematic cross section of an alternate embodiment of an optical storage medium.

FIG. 4 is a schematic cross section of an adapter for reading out an optical storage medium produced by an embodiment of the present invention.

### DETAILED DESCRIPTION

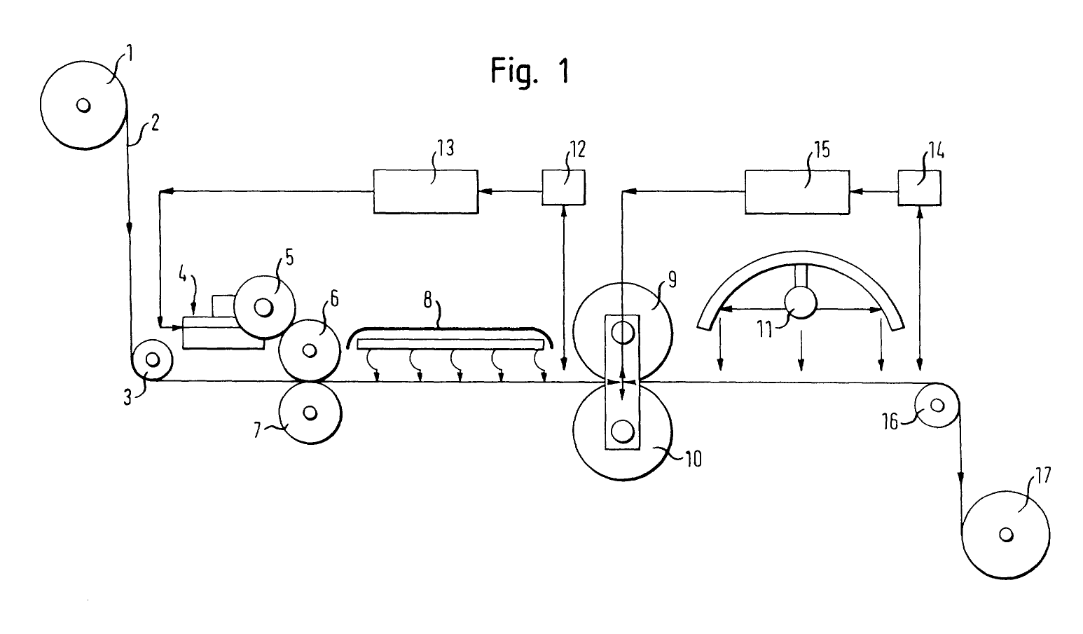

FIG. 1 provides a schematic diagram of an apparatus arranged to produce optical storage media. In the embodiment shown, a plastic film 2 having a width of approximately 1 meter (m) and thickness of approximately 50 μm is initially carried on and withdrawn from a take-off roller 1. After passing around a deflection roller 3, the plastic film 2 is passed between a coating roller 6 and a counter-roller 7. The coating roller 6 applies a layer of sol-gel with a thickness of about 1 μm to the plastic film 2. The sol-gel is contained in a reservoir 4 in which a cup roller 5 is immersed. The cup roller 5 transfers the adhering sol-gel to the coating roller 6. The application of a layer of material in this manner is known from the printing industry and will therefore not be explained in detail. Other known coating methods are also applicable.

The coated plastic film 2 then passes through a drying station 8, in which the solvent is at least largely removed by supplying heat. In a preferred embodiment, the heat is supplied by infrared irradiation. After being exposed to the heat of the drying station 8, the coating layer on the plastic film 2 is in a dried but embossable state. The term “embossable” is meant to describe a state in which a surface relief in the form of pits and lands can be taken from a corresponding embossing die with the required accuracy. The coating is dried to the extent that the plastic film 2 can be wound on a roller without the individual layers of film adhering to each other. As the coated plastic film 2 emerges from the drying station 8, a thickness measurement device 12 determines the thickness of the coating on the plastic film 2. In the embodiment shown, the thickness measurement device 12 is an interferometric film thickness. The thickness measurement device 12 transmits an output signal to a controller 13. If the controller 13 determines from the output signal that the coating thickness is beginning to vary from a desired range, it will adjust the amount of coating applied to the plastic film 2 at the coating station (namely, the reservoir 4 and rollers 5, 6 and 7). These adjustments are made in a known manner.

In one embodiment, the coated plastic film 2 is wound onto a carrier (not shown) and stored for further processing. This is advantageous because the steps of coating and drying take more time than the process of embossing. The production of the embossable substrate and the production of the actual storage media can take place separate from each other both in terms of time and place and thereby optimized. For example, two or more machines can fabricate the substrate, which is then processed into the storage media in a single machine.

However, in the embodiment of FIG. 1, the coated plastic film 2 is sent from the drying station 8 directly to an embossing station, represented by an embossing roller 9 and a pressure roller 10. The outer periphery of the embossing roller 9 is formed by a die which bears the negative of the surface structure to be generated in the coating of the tape. The embossing roller 9 transfers pits and lands into the coating of the plastic film 2. The pressure roller 10 is disposed opposite the embossing roller.

The embossing station is followed by a curing station 11. In a preferred embodiment, the curing station 11 comprises at least one UV light source. The UV light source initiates the radiation crosslinkage of the photopolymer contained in the coating. In a preferred embodiment, the coating material is irradiated with 40 to 1000 mJ/cm² for approximately one second. Radiation having a wavelength between 200 and 500 nm is also preferred. A relatively fast crosslinkage and resulting definitive fixation of the embossed surface structure is desirable. The maximum usable radiation capacity, duration of irradiation and radiation wavelength depends on the particular radiation crosslinkable polymer used. After the film 2 emerges from the curing station 11, a depth gauge 14 measures the depth of the pits formed in the coating by the embossing roller 9. In a preferred embodiment, the depth gauge 14 is an interferometric pit depth gauge. The depth gauge 14 produces an output signal as a function of the measured pit depths that is transmitted to a controller 15. The controller 15 compares the output signal from the depth gauge 14 with a desired value. If there is the output signal varies from the desired value, the controller 15 causes the pressure applied by the embossing roller 9 to be adjusted accordingly. When determining the dimensional geometry of the pits, primarily the depth thereof, it is important to determine whether the surface structure forms an interface with air or a transparent protective layer, in which case the layer's index of refraction should be considered. In the embodiment of FIG. 1, the coated and embossed plastic film 2 then travels around a deflection roller 16 and is wound onto a wind-up roller 17 for storage prior to further processing.

This additional processing includes punching the blanks out of the film 2 and punching a central hole into each blank (in certain embodiments, this step occurs simultaneously with the punching out of the blanks). In other embodiments, the blanks are metallized and a protective lacquer is applied. In an alternate embodiment, a protective film is laminated onto the blanks. In a further embodiment, an adapter is mounted to the blanks. In one embodiment, the adapter comprises an inner ring and an outer ring and gives the blank a desired thickness so that the blank is lifted into the reading or autofocus plane of a standard disk drive or reading device. The adapter is required where the blanks produced are considerably thinner than conventional optical storage devices because standard disk reading device are designed for the standard 1.2 mm thickness of conventional storage media.

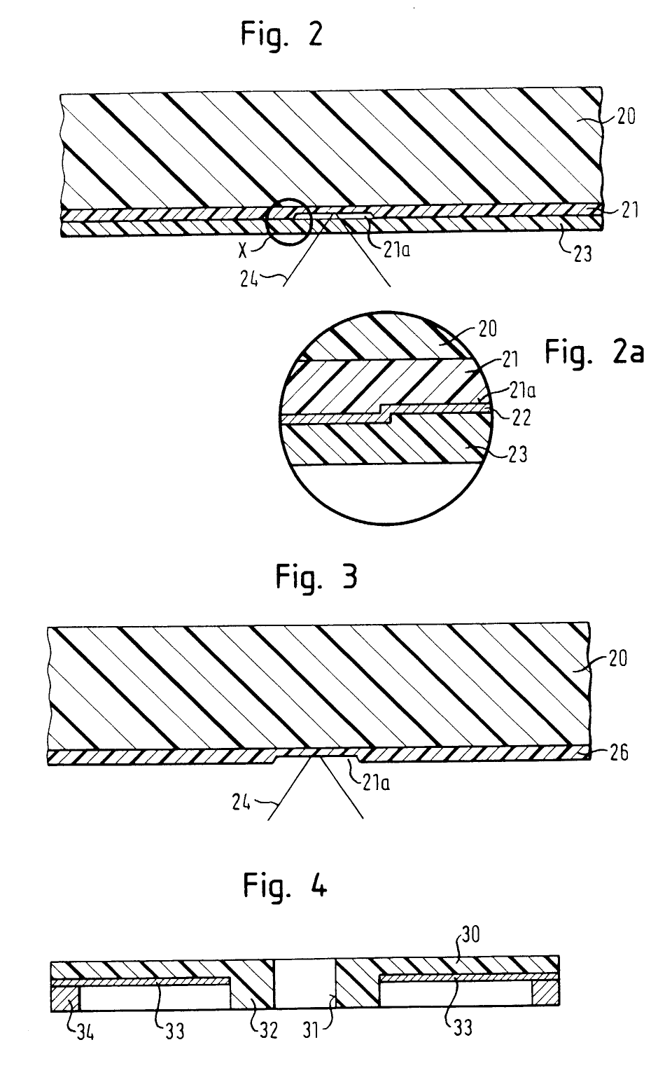

FIGS. 2, 2a, and 3 are considerably magnified representations of the optical storage device produced by the disclosed method. FIG. 2 shows a section through one embodiment of a storage medium corresponding to a blank punched out of the coated plastic film 2 of FIG. 1. The illustrated embodiment includes a polyester film 20 having a layer 21 of sol-gel. In an alternate embodiment, the layer 21 is comprised of a photopolymer. The layer 21 has face opposite the polyester film 20 that is embossed with pits 21a. In a preferred embodiment, the layer 21 has a refractive index (n) of approximately 1.5. In the embodiment of FIG. 2a, the face of layer 21 containing pits 21 a is provided with a metallization layer 22 and a layer of protective lacquer 23. The metallization layer 22 may be applied by the aluminum sputtering method, which is known in the art. A standard disk drive reading beam 24 reads out the sequence of embossed pits and lands.

FIG. 3 is a section through an alternate embodiment of the storage medium. In this embodiment, a layer 26 of TiO₂-based sol-gel is applied to the polyester film 20. In a preferred embodiment, the index of refraction of this layer 26 is in the range of 2 to 2.5. In that preferred embodiment, the reflectivity of the layer 26 is sufficient to lead to a large CA signal and, therefore, the additional metallization layer 22 of FIG. 2a is omitted. In an embodiment of the storage medium in which it is read out only once, for instance to copy the disc's contents onto the fixed disk drive of a computer, the protective layer 23 is superfluous. Instead, an adhesion film (not shown), which is simply peeled off before inserting the storage medium into the disk drive, is utilized to cover the information carrying side of the storage medium. However, in embodiments in which the storage medium will be read out repeatedly, the face of layer 21 containing pits 21a should be provided with the layer of protective lacquer 23. Alternatively, a protective film is laminated onto layer 21.

FIG. 4 illustrates an adapter suitable to position the information carrying surface of the storage medium to the proper level for being read when placed into a disk drive. The adapter is required in certain embodiments because the storage medium produced is considerably thinner than a conventional CD, DVD, or CD-ROM. The adapter places the information carrying surface of the storage medium in the same plane as the information carrying surfaces of a conventional CD, DVD, or CD-ROM. The adapter comprises a generally circular carrier plate 30. The carrier plate 30 has a central hole 31 with a diameter equal to that of the central hole of a conventional CD. An inner ring 32 protrudes on the future readout side of the adapter. This inner ring 32 serves to center the film-like storage medium 33. At its outer periphery, the storage medium 33 is fixed by an outer ring 34. The thickness of the outer ring 34 and the inner ring 32 are such that upon inserting the adapter into the tray of a disk drive, the information carrying surface of the film-like storage medium 33 is disposed at the same level at which the information-bearing surface of a CD or CD-ROM would be disposed.

The coating material used in the method is preferably a thixotropic material. Thixotropic materials exhibit a time-dependent response to shear strain rate over a longer period than that associated with changes in the shear strain rate. These materials may liquefy when shaken and subsequently solidify. The term structure viscosity can also be used to describe the characteristics of these materials. Suitable thixotropic materials are described in WO 01/51220 A2, the disclosure of which is herein incorporated by reference. In one embodiment, the material used for coating the plastic film 2 is a solvent-based radiation-crosslinkable polymer. Suitable polymers of this type are known in the art as photopolymers. In a preferred embodiment, the coating material is a solvent-based radiation-crosslinkable sol-gel. Suitable sol-gel systems having a SiO₂ base are known in the art (for example, see “Optical Disc Substrate Fabricated by the Sol-Gel Method” by A. Matsuda et al., published in Key Engineering Materials, Vol. 150 (1998), pp. 111-120). However these sol-gels were only considered useful for producing preformatted recordable optical storage media in the form of a correspondingly coated glass plate. In alternate embodiments utilizing sol-gel systems, other inert solids with grain sizes in the nanometer range, such as TiO₂, are exchanged for SiO₂. The material used for the plastic film is a polyester in one embodiment and a polycarbonate in another embodiment.

In a preferred embodiment, the viscosity of the coating material is between 10 and 100 mPa/s in its liquid state and between 20 and 100 Pa/s in a largely solidified condition, i.e., after drying. The thickness of the material is preferably between 2 and 100 μm and between 1 and 50 μm in the largely solidified condition, i.e., after drying.

The transport speed, the speed at which the plastic film is supplied, depends on the selected coating method, the duration of the drying step, the thickness of the layer of thixotropic material applied to the film, the maximum applicable heating capacity to achieve a uniform drying over the entire layer thickness, and the path length available for drying. In one embodiment, the transport speed is between 20 and 50 m/min.

The drying temperature has a lower limit of approximately room temperature and an upper limit dependent on the chemical stability of the coating material and the evaporation properties of the solvent. In a preferred embodiment, the drying temperature is between 50 and 90° C.

In an embodiment in which the step of embossing the coated film occurs immediately after the drying step, the embossing speed will necessarily equal the transport speed of the plastic film in the coating and drying steps. Alternatively, in an embodiment in which embossing occurs separately from the coating and drying steps, the embossing step may proceed at a higher rate. In one embodiment, the embossing speed is between 10 and 50 m/min.

In summary, one portion relates to a method of producing a substrate for fabricating optical storage media in which the information is stored serially in the form of pits and lands. The method includes the steps of: providing a supply of thixotropic material in liquid form; coating a sheet of plastic film with the thixotropic material in a layer of predetermined thickness; and applying heat to the coating of thixotropic material and drying the same to a semi-solid state. This produces the substrate.

Another portion relates to a method of producing optical storage media utilizing such a substrate having a semi-solid coating of thixotropic material one side thereof, including the steps of: providing an embossing face which contains a negative of a storage medium of information to be transferred; embossing the semi-solid coating of thixotropic material with the embossing face and thereby transferring the information to the semi-solid coating; and applying ultra violet energy to the embossed face of the semi-solid coating to cure the coating to a solid state.

Other objects, features and advantages of the present invention will be apparent to those skilled in the art. The invention in its broader aspects is not limited to the specific steps or the order of the steps, nor to the embodiments shown and described but departures may be made therefrom within the scope of the accompanying claims without departing from the principles of the invention and without sacrificing its chief advantages. The invention should not be limited except as required by the scope of the appended claims and their equivalents.

What is claimed is:

1. A method of producing optical storage media in which the information is stored serially in the form of pits and lands, including the steps of:
providing a supply of thixotropic material in liquid form;
coating a sheet of plastic film with the thixotropic material in a layer of predetermined thickness;
applying heat to the coating of thixotropic material and drying the same to a semi-solid state;
providing an embossing face which contains a negative of a storage medium of information to be transferred;
embossing the dried semi-solid coating of thixotropic material with the embossing face and thereby transferring the information to the semi-solid coating; and
applying ultra violet energy to the embossed face of the semi-solid coating to cure the coating to a solid state.

2. A method of producing optical storage media as set forth in claim 1, wherein the thixotropic material provided is a solvent-based photopolymer.

3. A method of producing optical storage media as set forth in claim 1, wherein the thixotropic material provided is a solvent-based radiation-crosslinkable sol-gel.

4. A method of producing optical storage media as set forth in claim 1, wherein the thixotropic material provided has a viscosity between 10 and 100 mPa/s.

5. A method of producing optical storage media as set forth in claim 4, wherein the thixotropic material provided has a viscosity between 20 and 100 mPa/s.

6. A method of producing optical storage media as set forth in claim 1, wherein the sheet of plastic film is coated with the thixotropic material in a layer with a thickness between 2 and 100 μm when the thixotropic material is in a liquid state.

7. A method of producing optical storage media as set forth in claim 1, wherein the sheet of plastic film is coated with the thixotropic material in a layer with a thickness between 1 and 50 μm when the thixotropic material is dry.

8. A method of producing optical storage media as set forth in claim 1, wherein the sheet of plastic film is supplied at a rate between 20 and 50 m/min.

9. A method of producing optical storage media as set forth in claim 8, wherein the sheet of plastic film is supplied at a rate of 25 m/min.

10. A method of producing optical storage media as set forth in claim 1, wherein heat between room temperature and 150° C. is applied to the coating of thixotropic material.

11. A method of producing optical storage media as set forth in claim 10, wherein heat between 50 and 90° C. is applied to the coating of thixotropic material.

12. A method of producing optical storage media as set forth in claim 1, wherein the coating of thixotropic material is embossed at a rate between 10 to 50 m/min.

13. A method of producing optical storage media as set forth in claim 12, wherein the coating of thixotropic material is embossed at a rate of approximately 25 m/min.

14. A method of producing optical storage media as set forth in claim 3, wherein 50 to 400 mJ/cm² of ultra violet energy is applied to the embossed face for a period of time sufficient for permanent fixation of the embossed face.

15. A method of producing optical storage media as set forth in claim 14, wherein ultra violet energy having a wavelength between 200 and 500 nm is applied to the embossed face.

16. A method of producing optical storage media as set forth in claim 1, further including the steps of:
measuring the thickness of the layer of thixotropic material applied to the sheet of plastic film after drying said layer of thixotropic material; and
using the measured value of the thickness of the layer of thixotropic material after drying to control the amount of thixotropic material applied to the sheet of plastic film.

17. A method of producing optical storage media as set forth in claim 1, further including the steps of:
measuring the depth of the features embossed into the coating of thixotropic material after curing the same; and
using the measured value of the depth of the features embossed into the coating of thixotropic material to control the pressure applied by the embossing face.

18. A method of producing optical storage media as set forth in claim 1, further including the step of metallizing at least one side of the plastic film after curing the coating of thixotropic material to a solid state.

19. A method of producing optical storage media as set forth in claim 1, further including the step of applying a layer of protective lacquer to the embossed face of the coating of thixotropic material after it has been cured to a solid state.

20. A method of producing optical storage media as set forth in claim 1, wherein the sheet of plastic film coated with the thixotropic material is a polyester.

21. A method of producing optical storage media as set forth in claim 1, wherein the sheet of plastic film coated with the thixotropic material is a polycarbonate.

22. A method of producing optical storage media in which the information is stored serially in the form of pits and lands, including the steps of:
providing a supply of thixotropic material in liquid form;
coating a sheet of plastic film with the thixotropic material in a layer of predetermined thickness; and
applying heat to the coating of thixotropic material and drying the same to a semi-solid state.

23. A method of producing optical storage media in which the information is stored serially in the form of pits and lands, including the steps of:
providing an embossing face which contains a negative of a storage medium of information to be transferred;
providing a substrate having a semi-solid coating of thixotropic material one side thereof;
embossing the semi-solid coating of thixotropic material with the embossing face and thereby transferring the information to the semi-solid coating; and
applying ultra violet energy to the embossed face of the semi-solid coating to cure the coating to a solid state.

24. An optical storage medium comprising:
a sheet of flexible plastic material;
a layer of ultra violet cured thixotropic material on the sheet of flexible plastic material, the thixotropic material having information embossed into a surface thereof opposite the flexible plastic material while the thixotropic material is in a semi-solid state and before curing; and
a protective coating extending over the embossed surface.
